(19) United States
(12) Patent Application Publication
(10) Pub. No.: US 2026/0079970 A1
(43) Pub. Date: Mar. 19, 2026

(54) GENERATING A CONCEPT GRAPH LINKING TABLES IN A DATABASE TO CONCEPTS FOR QUERIES USING A LARGE LANGUAGE MODEL

(71) Applicant: Adobe Inc., San Jose, CA (US)

(72) Inventors: Ramasuri Narayanam, Bangalore (IN); Saud Iqbal, Delhi (IN); Shaddy Garg, Baghapurana (IN); Shiv Kumar Saini, Bengaluru (IN); Som Satapathy, Bangalore (IN); Vidit Bhatia, Modi Nagar (IN)

(21) Appl. No.: 18/889,767

(22) Filed: Sep. 19, 2024

(51) Int. Cl. G06F 16/332; G06F 16/36; G06F 40/242; G06F 40/284

(52) U.S. Cl. CPC G06F 16/3329; G06F 16/367; G06F 40/242; G06F 40/284

(57) ABSTRACT

The present disclosure relates to systems, non-transitory computer-readable media, and methods for using a concept graph to select relevant tables relevant for querying a database. In particular, in some embodiments, the disclosed systems generate concept tags for tables in a database schema based on content of the tables corresponding to concepts in a list of concepts. Additionally, the disclosed systems generate a concept graph comprising hyper edges linking the tables to the concepts according to the concept tags. The disclosed systems determine, from the tables in the database schema, a set of tables relevant to a natural language query comprising an indicated concept by extracting the set of tables from one or more hyper edges corresponding to the indicated concept from the concept graph. The disclosed systems also generate, utilizing a large language model, a response for the natural language query from the set of relevant tables.

### BACKGROUND

Recent years have seen developments in hardware and software platforms for accessing and manipulating databases. For example, many entities utilize databases to organize and store large quantities of digital data. Additionally, such entities utilize structured database queries to extract specific digital information from the databases for display at other computing devices. Given the large amounts of digital data that are often stored in databases, executing structured database queries to determine types and locations of digital information within a database that are relevant to an intent underlying the structured database queries is a crucial and challenging task in managing digital data.

Although conventional systems provide information from a database in response to a structured database query, such systems have a number of problems in relation to flexibility of operation and efficiency. For instance, conventional systems are often inflexible in that they require a rigid syntax for executing a structured database query. Specifically, conventional systems often require the query to be stated (e.g., by a user or computer program) in a structured query language (SQL) format, which often requires in-depth knowledge of the contents of a database and the SQL format in such conventional systems.

While some conventional systems attempt to improve the flexibility of database queries by utilizing machine learning models to formulate structured database queries, such systems often are unable to parse relevant information from a database due to an excessive amount of data in the database based on over-selection of information to search the database. For example, conventional systems often require excessive computational resources (e.g., memory, storage, bandwidth, etc.) to execute queries on large amounts of data across many different tables in the databases. Additionally, conventional systems that utilize machine learning to execute queries on databases also suffer from resource costs associated with making large quantities of calls (e.g., via application programming interfaces) to machine learning models for each query. Thus, conventional systems often suffer from inefficient operation.

These along with additional problems and issues exist with regard to conventional database systems.

### BRIEF SUMMARY

Embodiments of the present disclosure provide benefits and/or solve one or more of the foregoing or other problems in the art with systems, non-transitory computer-readable media, and methods for querying a database by generating and utilizing a concept graph to determine tables relevant to a natural language query. Specifically, the disclosed systems generate a concept graph that links specific concepts to tables in a database schema based on the contents of the tables. In some embodiments, the disclosed systems generate the concept graph by generating concept tags for the tables based on the content of the tables and generating hyper edges that link the tables to specific concepts according to the concept tags. The disclosed systems utilize the concept graph to determine a set of tables relevant to a natural language query by extracting the relevant tables from one or more hyper edges corresponding to a concept indicated in the natural language query. Additionally, the disclosed systems utilize a large language model to generate a response for the natural language query by generating a structured database query on the set of tables relevant to the natural language query. Accordingly, the disclosed systems provide flexible, efficient database queries by selecting tables that are relevant to the queries via a concept graph.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a schema linking system operates in accordance with one or more implementations.

FIG. 2 illustrates a diagram of the schema linking system utilizing a concept graph to determine relevant tables in a database schema for a natural language query in accordance with one or more implementations.

FIG. 3 illustrates a diagram of the schema linking system generating concept tags for tables in a database schema based on a predetermined list of concepts in accordance with one or more implementations.

FIG. 4 illustrates a diagram of an example concept graph linking tables to concepts in accordance with one or more implementations.

FIG. 5 illustrates a diagram of an example dictionary including keys and values linking tables to concepts in a concept graph in accordance with one or more implementations.

FIG. 6 illustrates a diagram of the schema linking system determining a set of relevant tables for a natural language query in accordance with one or more implementations.

FIG. 7 illustrates a diagram of the schema linking system utilizing a structured database query to determine a structured database query result and a natural language response in accordance with one or more embodiments.

FIG. 8 illustrates a diagram of an example architecture of the schema linking system in accordance with one or more embodiments.

FIG. 9 illustrates a flowchart of a series of acts for generating and utilizing a concept graph for determining relevant tables in a database for a natural language query in accordance with one or more embodiments.

FIG. 10 illustrates a block diagram of an example computing device for implementing one or more embodiments of the present disclosure.

### DETAILED DESCRIPTION

This disclosure describes one or more embodiments of a schema linking system that generates responses to a natural language query by selecting a relevant set of tables in a database via the use of a concept graph. For example, the schema linking system links a database schema to concepts via a concept graph by linking tables in the database schema to the concepts based on the content of the tables. The schema linking system determines one or more concepts indicated in a natural language query and utilizes the concept graph to select one or more tables that correspond to the indicated concepts based on the relationships in the concept graph. In one or more embodiments, the schema linking system utilizes a large language model to generate a response to the natural language query using the tables relevant to the natural language query. The schema linking system thus leverages relationships between a list of allowed concepts and tables in a database to construct a concept graph for improving the efficiency and flexibility of responses to natural language queries to a database.

As mentioned, in one or more embodiments, the schema linking system generates a concept graph indicating relationships between tables and a list of concepts. In particular, the schema linking system extracts content from tables in a database to determine whether the tables correspond to concepts in a predetermined list of concepts and assigns corresponding concept tags to the tables. Additionally, the schema linking system generates the concept graph by generating hyper edges that link the tables to specific concepts according to the concept tags. For example, the schema linking system generates a dictionary of key-value mappings between the concepts and the corresponding tables.

Additionally, in one or more embodiments, the schema linking system utilizes the concept graph to select a set of tables relevant to a natural language query. Specifically, the schema linking system determines one or more concepts in the natural language query that match one or more concepts in the predetermined list of concepts, such as by tokenizing the natural language query and comparing to tokenized concepts. The schema linking system utilizes the indicated concepts to search the concept graph for tables by extracting specific values from hyper edges based on the keys matching the indicated concepts. Accordingly, the schema linking system determines tables relevant to the natural language query by extracting the relevant tables from the hyper edges of the concept graph.

Furthermore, in one or more embodiments, the schema linking system utilizes the relevant tables to generate a response to the natural language query, such as in a natural language to structured query operation. In particular, the schema linking system generates a prompt to a large language model to generate a request to the database (e.g., in SQL format) based on the relevant tables. More specifically, the schema linking system generates the response to the natural language query by leveraging a large language model to create a structured database query for searching only the tables in the database relevant to the natural language query. In some embodiments, the schema linking system also utilizes the large language model to generate a natural language response to the query based on the results returned from the query to the database.

The schema linking system provides a variety of improvements to conventional systems. For example, by generating a concept graph linking tables in a database schema to a list of concepts, the schema linking system provides improved flexibility and efficiency of a computing system that implements a database query. Specifically, the schema linking system enables client devices to submit a query to a database in a natural language format without the rigidity of structured query formats. Accordingly, the schema linking system leverages the concept graph with a large language model to convert natural language queries to structured database queries that target only relevant tables in a database without requiring user knowledge of the contents of the tables in the database for creating and formatting the query. Furthermore, the schema linking system provides accurate results across diverse datasets and varying schema structures.

Additionally, by leveraging the concept graph to identify relevant tables for a natural language query to a database, the schema linking system increases computing efficiency of the computing systems executing the query to the database. For example, by selecting relevant tables to use in executing a database query, the schema linking system reduces the amount of data that the database processes to respond to the query, especially in use cases involving databases with many tables (e.g., tens or hundreds of tables). To illustrate, in contrast to conventional systems that require a significant amount of processing resources to execute database queries for databases including a large number of tables, the schema linking system executes database queries utilizing only tables that are relevant to a natural language query. In particular, by leveraging relationships between tables and a predetermined list of concepts via a concept graph, in some embodiments, the schema linking system generates structured database queries that include only the relevant tables (e.g., by including only the relevant tables in a prompt to a large language model).

Accordingly, the schema linking system improves accuracy, flexibility, and efficiency by providing accurate results (e.g., relative to an intent of the natural language query) in a response from the database query while reducing the processing overhead at the database and increasing the available methods for querying the database. To illustrate, the schema linking system provides database querying that limits the number of locations (e.g., tables) touched by each query by restricting searches to only relevant portions. Furthermore, the schema linking system reduces processing at the large language model by limiting the prompt to the large language model to only the relevant tables. Additionally, as noted previously, the schema linking system provides accurate and efficient database querying while expanding the possible methods of querying a database (e.g., including natural language queries that leverage a large language model) by taking advantage of the relationships indicated in the concept graph.

Furthermore, the schema linking system improves efficiency in computing systems that implement database queries with machine-learning. Specifically, by using a concept graph to leverage relationships between specific concepts and database tables with prompt engineering, the schema linking system reduces reliance on extensive fine-tuning of language models over tabular data. Accordingly, the schema linking system reduces training time and computing resource consumption, thereby extending the accessibility to many more use cases and device architectures.

As illustrated by the foregoing discussion, the present disclosure utilizes a variety of terms to describe features and advantages of the schema linking system. For example, as used herein, the term “database schema” refers to an organizational structure of a database including digital data. To illustrate, a database schema is a blueprint of how data is stored within the database. For instance, a database schema includes tables and relational information about the tables, as well as metadata for the tables.

In one or more embodiments, as used herein, the term “table” refers to an arrangement of digital data. For example, a table includes data stored in a row/column format with cells storing specific values corresponding to the rows/columns, though other types of tables include other types of formats (e.g., multiple variable tables, nested tables, grouped tables). Additionally, as used herein, the term “atomic table” refers to a table containing atomic information about an individual entity or distinguishable group/segment. For example, an atomic table contains data that is particularized for a single entity (e.g., a distinct group or segment of users). Furthermore, as used herein, the term “bridge table” refers to a table that contains information about how multiple entities are interconnected. For example, a bridge table includes data that describes relationships between two or more atomic tables corresponding to two or more entities.

As used herein, the term “relevant table” (or “table relevant to a query”) refers to a table in a database schema that contains information relevant to a natural language query. For example, a relevant table includes a table in the database schema that includes data necessary to or helpful to answering a query to a database. In some embodiments, a relevant table includes an atomic table or a bridge table according to concepts indicated in a query and relationships in a concept graph. Accordingly, in some embodiments, a set of relevant tables includes two or more atomic tables and one or more bridge tables linking the atomic tables.

As used herein, the term “concept graph” refers to a digital representation of relationships between concepts and tables. For example, a concept graph indicates relationships between concepts in a predetermined list of concepts and tables in a database based on the contents of the tables in relation to the concepts in the predetermined list of concepts. In one or more embodiments, a concept graph includes hyper edges representing the relationships between the tables and the concepts. Specifically, as used herein, the term “hyper edge” refers to a set of one or more concepts that are linked to one or more tables. For instance, a hyper edge includes a node in a concept graph that indicates a set of concepts that each correspond to a set of tables. In some embodiments, a concept or table is included in more than one hyper edge (e.g., such that two hyper edges overlap).

Furthermore, as used herein, the term “concept” refers to a word or phrase representing an idea. In some embodiments, a concept indicates a physical object or a non-physical idea. Some examples of concepts include “dataset,” “profile,” “segment,” “event,” “user,” “destination,” “data flow,” “source,” etc. Additionally, as used herein, the term “predetermined list of concepts” refers to a set of concepts indicated as allowed concepts for searching a database (e.g., thus restricting searches in a database to only the allowed concepts) for one or more specific purposes. Furthermore, as used herein, the term “concept tag” refers to an assignment of a table to a specific concept. To illustrate, a concept tag includes a metadata tag in metadata of a table to indicate that the table corresponds to a concept based on contents of the table.

As used herein, the term “natural language query” refers to a semantic input requesting information about a database or requesting operations to be performed on the database and formatted using natural/plain language. For example, a natural language query includes a question or command in plain language that seeks information about data and/or tables of a database.

As used herein, the term “structured database query” refers to a command in a structured query format (e.g., SQL format or DDL format) that seeks information from a database or that requests performance of an operation on the database. For example, a structured database query is translated from a natural language query into the structured query format for executing at the database.

Relatedly, as used herein, the term “large language model” refers to an artificial intelligence model capable of processing and generating natural language text or other language-based prompts using language understanding. In particular, large language models are trained on large amounts of data to learn patterns and rules of language. As such, a large language model post-training is capable of generating output predictions that indicate visualization structures. Further, in some embodiments, a large language model includes or refers to one or more transformer-based neural networks capable of processing language-based prompts (e.g., natural language text) to generate outputs that range from predictive outputs, analyses, or combinations of data within stored content items. In particular, a large language model includes parameters trained (e.g., via deep learning) on large amounts of data to learn patterns and rules of language for summarizing and/or generating digital content. In one or more embodiments, the software action planning system utilizes a large language model as described by Jivat Neet Kaur, Sumit Bhatia, Milan Aggarwal, Rachit Bansal, and Balaji Krishnamurthy in “LM-CORE: Language Models with Contextually Relevant External Knowledge” in arXiv:2208.06458v1, 2022, which is herein incorporated by reference in its entirety. In some embodiments, a large language model is trained to perform computer tasks to generate a structured database query in response to a natural language query and generate a natural language response based on the result of the structured database query.

As used herein, the term “normalized token” refers to a base word corresponding to a tokenized word. For example, a normalized token includes the smallest part of a word that retains a semantic meaning of a word without prefixes or suffixes. To illustrate, a normalized token for “segments” is “segment,” and a normalized token for “untrained” is “train.”

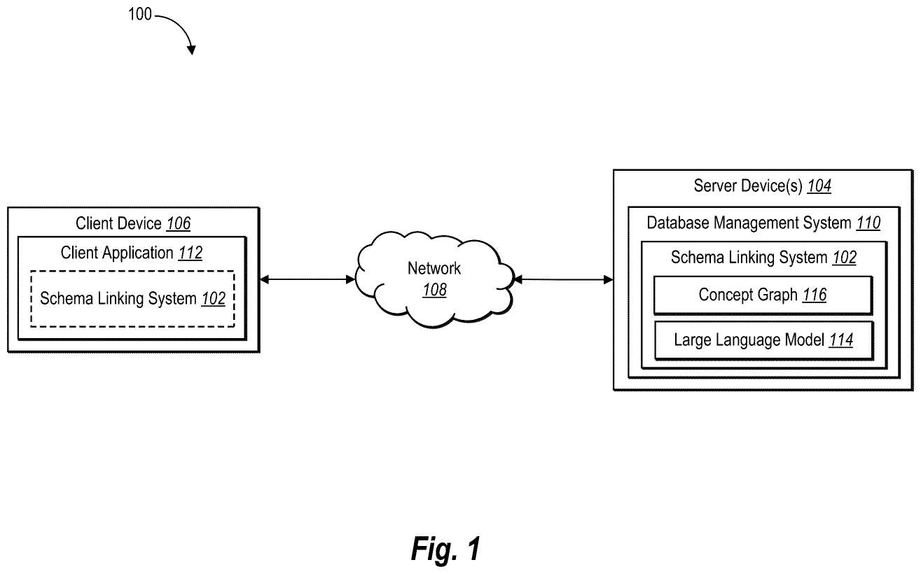

Turning now to the figures, FIG. 1 includes an embodiment of a system environment 100 in which a schema linking system 102 is implemented. In particular, the system environment 100 includes server device(s) 104 and a client device 106 in communication via a network 108. Moreover, as shown, the server device(s) 104 include a database management system 110, which includes the schema linking system 102. Furthermore, the client device 106 includes a client application 112, which optionally includes the schema linking system 102 (or the database management system 110).

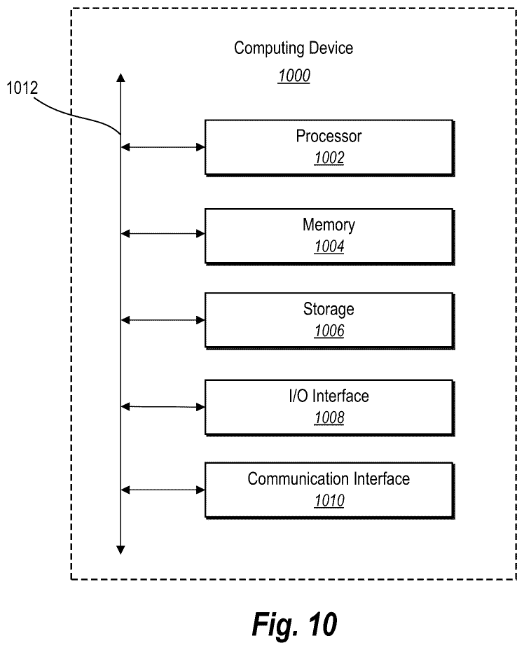

As shown in FIG. 1, the server device(s) 104 includes a database management system 110 that further includes the schema linking system 102. In one or more embodiments, the database management system 110 performs various operations to manage one or more databases, such as storing information in a database or executing queries on the database. In some embodiments, the schema linking system 102 of the database management system 110 determines tables in a database (e.g., represented by a database schema) that are relevant to a natural language query for use in executing one or more queries on the database. In some embodiments, the schema linking system 102 utilizes a machine learning model (such as a large language model 114) to convert a natural language query to a structured database query and to generate a response for the natural language query based on the results of the structured database query. In some embodiments, the server device(s) 104 includes, but is not limited to, a computing device (such as explained below with reference to FIG. 10).

As illustrated in FIG. 1, the schema linking system 102 is implemented on the client device 106 or on the server device(s) 104. In particular, in some implementations, the schema linking system 102 on the server device(s) 104 supports the schema linking system 102 on the client device 106. For instance, the server device(s) 104 generates or obtains the schema linking system 102 for the client device 106 (e.g., as part of a software application or suite). The server device(s) 104 provides the schema linking system 102 to the client device 106 for performing database management processes at the client device 106. In other words, the client device 106 obtains (e.g., downloads) the schema linking system 102 from the server device(s) 104. At this point, the client device 106 is able to utilize the schema linking system 102 to manage databases independently from the server device(s) 104.

In additional embodiments, although FIG. 1 illustrates the server device(s) 104 and the client device 106 communicating via the network 108, the various components of the system environment 100 communicate and/or interact via other methods (e.g., the server device(s) 104 and the client device 106 communicate directly). Furthermore, although FIG. 1 illustrates the schema linking system 102 being implemented by a particular component and/or device within the system environment 100, the schema linking system 102 is implemented, in whole or in part, by other computing devices and/or components in the system environment 100. For example, in some embodiments, the server device(s) 104 include or host the database management system 110 and/or the schema linking system 102.

To illustrate, the schema linking system 102 includes a web hosting application that allows the client device 106 to interact with content and services hosted on the server device(s) 104 (e.g., in a software as a service implementation). To illustrate, in one or more implementations, the client device 106 accesses a web page supported by the server device(s) 104. The client device 106 provides input to the server device(s) 104 to view information for database management tasks and, in response, the schema linking system 102 or the database management system 110 on the server device(s) 104 performs operations to manage databases (e.g., including database querying via concept a concept graph 116). The server device(s) 104 provide the output or results of the operations to the client device 106.

In one or more embodiments, the server device(s) 104 include a variety of computing devices, including those described below with reference to FIG. 10. For example, the server device(s) 104 include one or more servers for storing and processing data associated with database management processes. In some embodiments, the server device(s) 104 also include a plurality of computing devices in communication with each other, such as in a distributed storage environment. In some embodiments, the server device(s) 104 include a content server. The server device(s) 104 also optionally include an application server, a communication server, a web-hosting server, a social networking server, a digital content campaign server, or a digital communication management server.

In addition, as shown in FIG. 1, the system environment 100 includes the client device 106. In one or more embodiments, the client device 106 includes, but is not limited to, a mobile device (e.g., smartphone or tablet), a laptop, a desktop, including those explained below with reference to FIG. 10). Furthermore, although not shown in FIG. 1, the client device 106 is operable by a user (e.g., a user included in, or associated with, the system environment 100) to perform a variety of functions. In particular, the client device 106 performs functions such as, but not limited to, accessing, viewing, modifying, and querying databases (e.g., tables in a database). In some embodiments, the client device 106 also performs functions for generating queries (e.g., natural language queries) to provide to the database management system 110 and the schema linking system 102 in connection with querying databases. For example, the client device 106 communicates with the server device(s) 104 via the network 108 to provide information (e.g., user interactions) associated with database management. Although FIG. 1 illustrates the system environment 100 with a single client device, in some embodiments, the system environment 100 includes a different number of client devices.

Additionally, as shown in FIG. 1, the system environment 100 includes the network 108. The network 108 enables communication between components of the system environment 100. In one or more embodiments, the network 108 may include the Internet or World Wide Web. Additionally, the network 108 optionally include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server device(s) 104 and the client device 106 communicates via the network using one or more communication platforms and technologies suitable for transporting data and/or communication signals, including any known communication technologies, devices, media, and protocols supportive of data communications, examples of which are described with reference to FIG. 10.

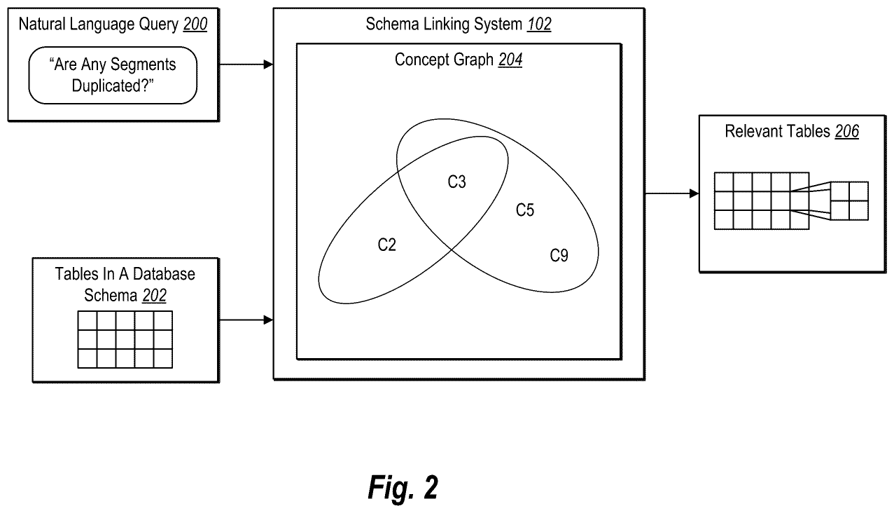

As discussed, in some embodiments, the schema linking system 102 utilizes a concept graph to determine a set of tables relevant to a natural language query for querying a database. For instance, FIG. 2 illustrates a diagram of the schema linking system 102 determining tables relevant to a natural language query via a concept graph. Specifically, FIG. 2 illustrates that the schema linking system 102 selects a specific subset of tables from a database in response to determining that the tables are relevant to the natural language query.

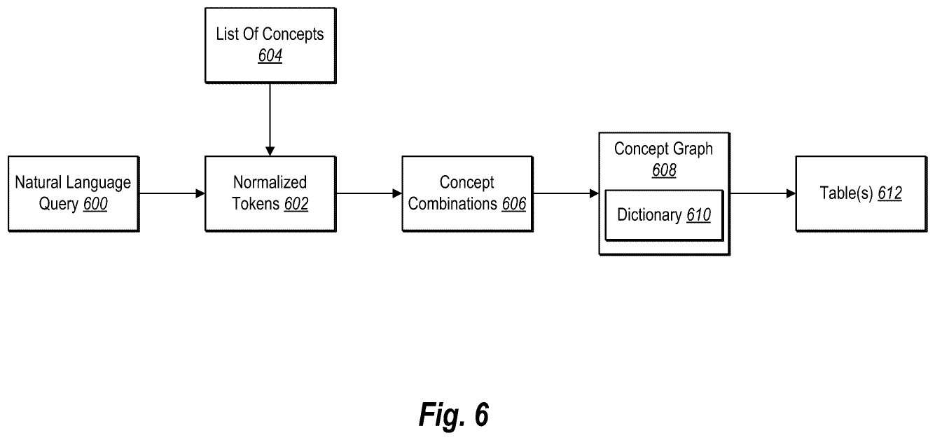

In particular, FIG. 2 illustrates the schema linking system 102 obtaining a natural language query 200. For instance, the schema linking system 102 receives the natural language query 200 from a client device in response to a user input to the client device generating the natural language query 200. In some cases, the natural language query 200 includes one or more natural language sentences or phrases (e.g., in a question or command) seeking information about data stored in the database. As an example, the natural language query 200 includes a request to determine whether the database includes duplicate entries for a particular segment. FIG. 6 and the corresponding description provide additional detail in relation to determining concepts indicated in a natural language query.

In one or more embodiments, as illustrated in FIG. 2, the schema linking system 102 also accesses tables in a database schema 202 for performing a database query. For example, the schema linking system 102 accesses a database to determine the tables in the database schema 202. In some embodiments, the schema linking system 102 determines a plurality of database schemas associated with a plurality of databases for performing one or more database queries.

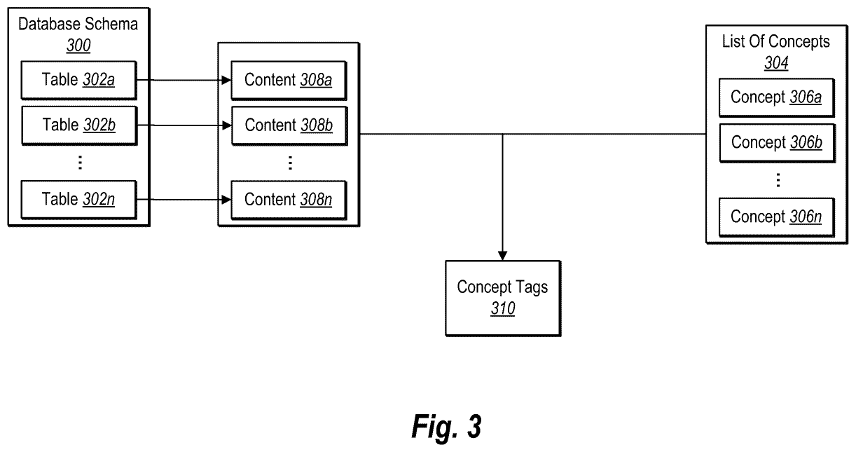

FIG. 2 illustrates that the schema linking system 102 generates a concept graph 204 to utilize in performing database queries. Specifically, the schema linking system 102 generates the concept graph 204 to indicate relationships between specific concepts and the tables in the database schema 202 based on the contents of the tables. FIGS. 3-5 and the corresponding description provide additional description related to generating a concept graph based on contents of tables in a database.

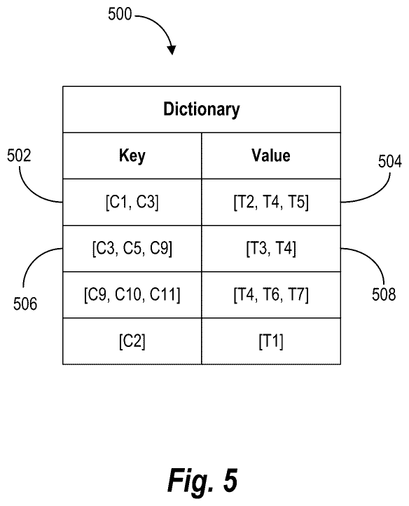

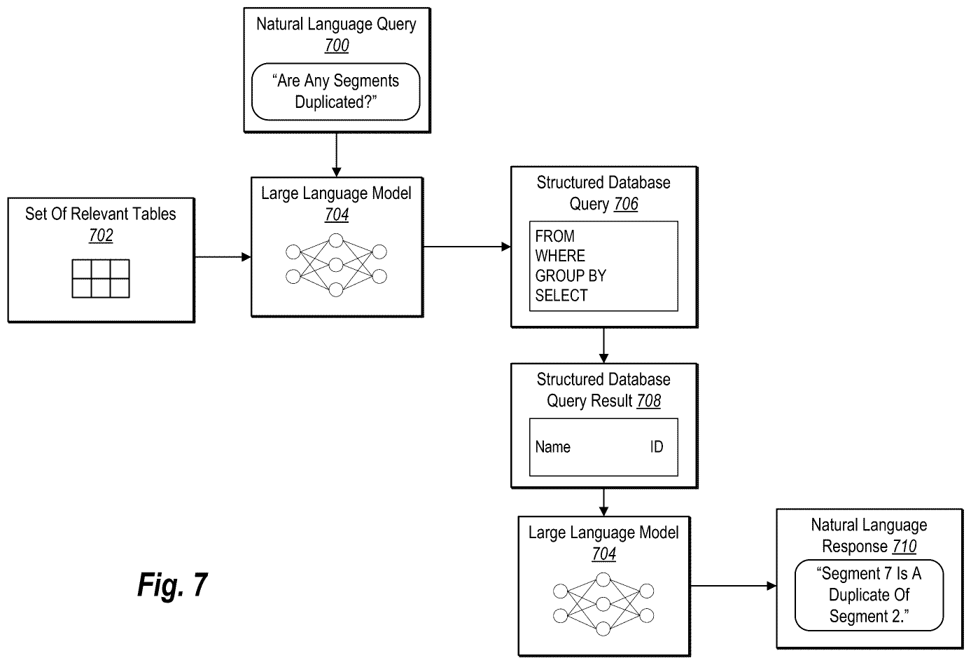

In one or more embodiments, the schema linking system 102 utilizes the concept graph 204 to select relevant tables 206 for the natural language query 200. In particular, the schema linking system 102 selects the tables that are most relevant to the natural language query 200 by leveraging the relationship information in the concept graph 204 to identify one or more tables that correspond to concepts indicated in the natural language query 200. FIGS. 5-6 and the corresponding description provide additional detail in relation to determining tables relevant to a natural language query based on a concept graph. Furthermore, FIG. 7 and the corresponding description provide additional detail related to generating a response to a natural language query to perform a database query.

As mentioned, the schema linking system 102 generates a concept graph by determining relationships between tables and specific concepts. FIG. 3 illustrates an example of the schema linking system 102 determining relationships between tables and a predetermined list of concepts based on the contents of the tables. Additionally, FIG. 3 illustrates that the schema linking system 102 assigns concept tags to the tables based on the determined relationships.

In one or more embodiments, the schema linking system 102 determines a database schema 300 including tables 302a-302n. For example, each table includes data related to one or more concepts. To illustrate, a database including data corresponding to a plurality of users of one or more products or services has a database schema that stores the data in a plurality of tables with different details associated with the users, products/services, details about relationships between the users and products/services, or other data. Accordingly, each table has a specific amount and/or type of data (e.g., stored in cells in a row/column format) depending on the database schema 300 as serves various implementations.

According to one or more embodiments, the schema linking system 102 determines relationships between the tables 302a-302n in the database schema 300 and a list of concepts 304. In particular, the schema linking system 102 determines the list of concepts 304 including concepts 306a-306n according to a particular implementation. For example, the list of concepts 304 includes a predetermined list of concepts that indicates the concepts 306a-306n that are allowed for performing database queries on the tables 302a-302n. To illustrate, although the tables 302a-302n include various data types and concepts, the schema linking system 102 utilizes the list of concepts 304 to potentially limit which concepts in the tables 302a-302n are searchable.

In one or more embodiments, the schema linking system 102 determines whether the tables 302a-302n in the database schema 300 correspond to the concepts 306a-306n in the list of concepts 304. Specifically, the schema linking system 102 extracts contents of the tables 302a-302n to determine whether the tables 302a-302n correspond to the concepts 306a-306n. For instance, the schema linking system 102 extracts contents 308a-308n of the tables 302a-302n from cell data, row or column data (e.g., row or column names), or metadata of the tables 302a-302n. In some embodiments, the schema linking system 102 utilizes a text extraction model to extract text content from the tables 302a-302n.

Additionally, in some embodiments, the schema linking system 102 determines relationships between the contents 308a-308n of the tables 302a-308n and the concepts 306a-306n in the list of concepts 304. For example, the schema linking system 102 determines whether each concept in the list of concepts 304 corresponds to a particular table based on a comparison of the content of the table to each concept. In one or more embodiments, the schema linking system 102 utilizes a neural network to compare the content of a table (e.g., content 308a of table 302a) to each of the concepts 306a-306n to generate a prediction of whether each concept corresponds to the table (e.g., based on embeddings of the concepts and table contents). Alternatively, in some embodiments, the schema linking system 102 performs a direct comparison of the concepts 306a-306n to the content of the table by searching for specific terms in the content of the table. In additional embodiments, the schema linking system 102 utilizes labeled table data (e.g., in a training dataset) to determine relationships between the tables 302a-302n and the concepts 306a-306n.

In response to determining relationships between the tables 302a-302n and the concepts 306a-306n, the schema linking system 102 links each table to one or more corresponding concepts based on the relationships. For example, as illustrated in FIG. 3, the schema linking system 102 generates concept tags 310 for the tables 302a-302n to link the tables 302a-302n to the corresponding concepts. To illustrate, in response to determining that table 302a is linked to concept 306a and concept 306b, the schema linking system 102 generates concept tags indicating the relationship to concept 306a and concept 306b. In some embodiments, the schema linking system 102 assigns the concept tags 310 to the tables 302a-302n by inserting the concept tags into metadata for the tables 302a-302n. In alternative embodiments, the schema linking system 102 assigns the concept tags 310 to the tables 302a-302n by generating a mapping of concept tags to tables in a separate data structure. In one or more embodiments, the schema linking system 102 assigns the concept tags 310 in a pre-processing step prior to receiving database queries.

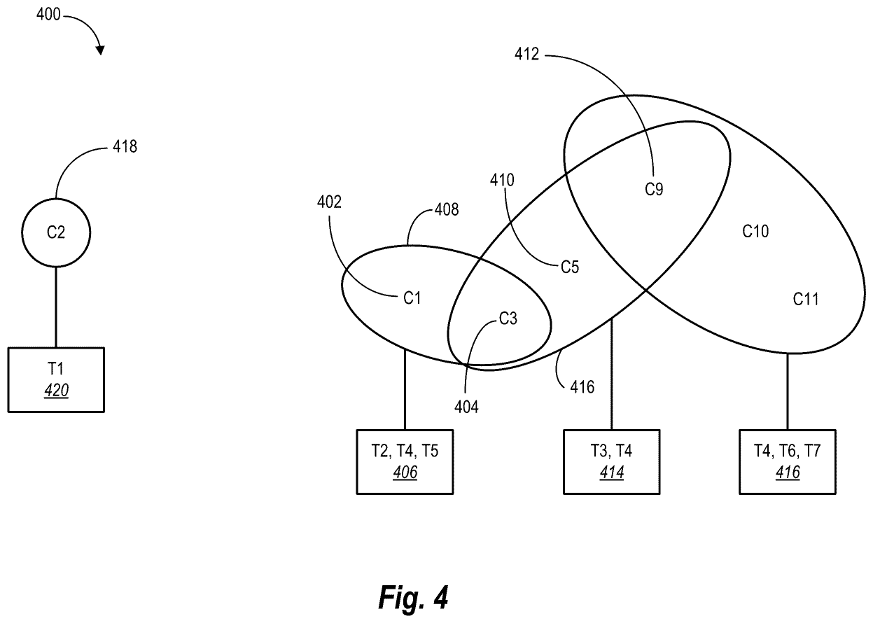

In response to generating concept tags for tables, the schema linking system 102 generates a concept graph indicating relationships between concepts and tables. FIG. 4 illustrates an example of a concept graph 400 based on determined relationships between tables and concepts. As illustrated, for example, the schema linking system 102 generates the concept graph 400 including hyper edges that link the concepts to the tables according to the concept tags of the tables.

In one or more embodiments, as illustrated in FIG. 4, the schema linking system 102 constructs the concept graph 400 by generating hyper edges that correspond to specific concepts based on relationships between the concepts and one or more tables. In particular, in response to determining that a set of concepts is linked to a set of tables (e.g., the tables include content related to the concepts), the schema linking system 102 generates a hyper edge representing the link. For example, as illustrated, the schema linking system 102 determines that a first concept 402 (“C1”) and a second concept 404 (“C3”) correspond to a first set of tables 406 (“T2,” “T4,” “T5”). Accordingly, the schema linking system 102 generates a first hyper edge 408 that links the first concept 402 and the second concept 404 to the first set of tables 406.

In an additional example, the schema linking system 102 determines that the second concept 404, a third concept 410 (“C5”), and a fourth concept 412 (“C9”) correspond to a second set of tables 414 (“T3,” “T4”). The schema linking system 102 thus generates a second hyper edge 416 that links the second concept 404, the third concept 410, and the fourth concept 412 to the second set of tables 414. As further illustrated, the first hyper edge 408 and the second hyper edge 416 share a concept (the third concept 410). Additionally, the first set of tables 406 and the second set of tables 414 overlap (“T3”). Accordingly, the schema linking system 102 generates the concept graph 400 to indicate sets of tables that correspond to the same concepts, which possibly result in overlaps of concepts in hyper edges or tables in corresponding sets of tables.

Additionally, in one or more embodiments, the schema linking system 102 generates hyper edges to indicate a relationship between a single concept and a single table, a single concept and a plurality of tables, or a plurality of concepts and a single table. For example, as illustrated in FIG. 4, the schema linking system 102 generates a third hyper edge 418 that includes a single concept (“C2”) linked to a set of tables 420 including a single table (“T1”).

In one or more embodiments, the schema linking system 102 constructs the concept graph 400 including a description of tables in a database. For example, the description of each table includes metadata associated with the table; a description of the table generated or provided by the database (or other system or application); or a textual description of a table name, column names, or row names. Thus, in some embodiments, the schema linking system 102 utilizes information provided with, or extracted from, the tables to determine how a concept links to a particular table.

As described in relation to FIGS. 3-4, the schema linking system 102 performs operations for utilizing content of tables in a database schema to link the tables to specific concepts in a concept graph. The operations allow the schema linking system 102 to more accurately and efficiently execute database operations based on natural language queries according to concepts identified in the natural language queries. Accordingly, the acts and operations illustrated and described above in relation to FIGS. 3-4 provide the corresponding acts (e.g., structure) for a step for generating a concept graph comprising hyper edges linking tables in a database schema to concepts in a predetermined list of concepts.

In one or more embodiments, generating hyper edges in a concept graph includes generating a dictionary of key-value mappings to store relationships between concepts and tables. FIG. 5 illustrates an example of a dictionary 500 of key-value mappings. Specifically, the schema linking system 102 generates the dictionary 500 by generating keys representing hyper edges and values representing sets of tables assigned to the corresponding keys.

For instance, the schema linking system 102 generates a first key 502 representing a first hyper edge corresponding to a set of concepts. As illustrated, the first hyper edge corresponds to the set of concepts “[C1, C3]” (e.g., as in FIG. 4), such that the schema linking system 102 generates the first key 502 as “[C1, C3]” (or other representation of the set of concepts). Additionally, the schema linking system 102 generates a first value 504 assigned to the first key 502 to indicate the set of tables (e.g., “[T2, T4, T5]” as in FIG. 4) linked to the set of concepts. Thus, the schema linking system 102 generates the value as “[T2, T4, T5]” (or other representation of the set of tables).

As an additional example, the schema linking system 102 generates a second key 506 representing a second hyper edge corresponding to an additional set of concepts. As illustrated, the second hyper edge corresponds to the additional set of concepts “[C3, C5, C9],” such that the schema linking system 102 generates the second key 506 indicating the additional set of concepts. Furthermore, the schema linking system 102 generates a second value 508 indicating the corresponding set of tables “[T3, T4]” and stores the second key 506 and the second value 508 in the dictionary 500 of the concept graph.

In one or more embodiments, the schema linking system 102 stores each key-value mapping for a hyper edge involving a set of concepts and a set of tables as a separate table (e.g., as indicated in FIG. 5) with a database or at a separate storage location pointing to the database. Alternatively, in some embodiments, the schema linking system 102 stores key-value mappings in a vector. For example, the schema linking system 102 stores each key-value mapping as a separate vector. To illustrate, the schema linking system 102 generates a first vector as {“[C1, C3]”: “[T2, T4, T5]”} to represent the first key 502 and the first value 504. In additional examples, the schema linking system 102 stores all key-value mappings in a dictionary as a single vector (e.g., {“[C1, C3]”: “[T2, T4, T5]”, “[C3, C5, C9]”: “[T3, T4]”, . . . } to represent a plurality of key-value mappings illustrated in FIG. 5.

As described in more detail below, the schema linking system 102 utilizes the dictionary 500 of the concept graph to determine relevant tables for a database query. Thus, in response to receiving (or otherwise determining) a database query, the schema linking system 102 accesses the dictionary 500 and extracts relevant tables for a given concept (or group of concepts). In some embodiments, the schema linking system 102 accesses the dictionary 500 stored at the schema linking system 102 prior to accessing the database. Alternatively, the schema linking system 102 stores the dictionary 500 at the database and accesses the dictionary 500 from the database in response to determining that the query corresponds to the database.

In one or more embodiments, in response to generating a concept graph with a dictionary of key-value mappings linking tables in a database to concepts, the schema linking system 102 utilizes the concept graph to determine relevant tables to a database query. For example, FIG. 6 illustrates an example of the schema linking system 102 utilizing a concept graph to determine relevant tables for a natural language query. As illustrated in FIG. 6, the schema linking system 102 determines whether the natural language query corresponds to concepts in the concept graph to select the relevant tables.

As illustrated in FIG. 6, the schema linking system 102 determines a natural language query 600 to perform one or more database operations. In one or more embodiments, the schema linking system 102 receives the natural language query 600 from a client device to perform the one or more database operations on a specific database. Additionally, in one or more embodiments, the schema linking system 102 processes the natural language query 600 to determine concepts indicated in the natural language query 600. For example, the schema linking system 102 tokenizes the natural language query 600, such as by utilizing a text parser or other natural language processor.

In one or more embodiments, the schema linking system 102 determines normalized tokens 602 from the natural language query 600. For example, the schema linking system 102 determines the normalized tokens 602 by obtaining base words (e.g., base English words without prefixes or suffixes). As mentioned, previously, an example of a normalized token includes the base word “segment” from “segments” and “segmented.” In an additional example, the schema linking system 102 determines the base word “experience” from “experiences” or “experienced.” Thus, the schema linking system 102 determines the normalized tokens 602 to obtain a consistent representation of tokens extracted from natural language queries. In some embodiments, the schema linking system 102 also removes stop words from the natural language query 600 prior to determining the normalized tokens 602.

Furthermore, as illustrated in FIG. 6, the schema linking system 102 determines whether the normalized tokens 602 extracted from the natural language query 600 match allowed concepts for database queries. Specifically, the schema linking system 102 determines concepts in the list of concepts 604 and checks whether each of the normalized tokens 602 is in the list of concepts 604. In response to determining that a particular normalized token is in the list of concepts 604, the schema linking system 102 adds the normalized token to a list of queryable tokens. In response to determining that a particular normalized token is not in the list of concepts 604, the schema linking system 102 discards the normalized token and does not use the normalized token for querying the database.

In additional embodiments, the schema linking system 102 determines whether queryable concepts in the natural language query 600 are in a concept graph 608. In particular, the schema linking system 102 searches for the normalized tokens 602 in a dictionary 610 of the concept graph 608. In some embodiments, the schema linking system 102 determines concept combinations 606 based on different combinations of the normalized tokens 602 to use in searching the dictionary 610. For example, the schema linking system 102 iterates through the normalized tokens 602 and finds all possible combinations (singletons, pairs, sets of three, etc.) to use in searching the dictionary 610 for matches. In one or more embodiments, the schema linking system 102 determines the concept combinations 606 in response to determining that the combination of all normalized tokens in the natural language query 600 are not found in the concept graph 608.

In one or more embodiments, the schema linking system 102 uses the concept graph 608 to select a set of relevant tables (e.g., table(s) 612) relevant to the natural language query 600 based on the concept combinations 606. For instance, the schema linking system 102 determines that the normalized tokens 602 include relevant concepts corresponding to the list of concepts 604 as [“attribute”, “dataset”, “segment”]. In one or more embodiments, the schema linking system 102 first performs a search on the concept graph 608 using the full set (e.g., [“attribute”, “dataset”, “segment”]). In response to determining that the full set is not found in the dictionary 610, the schema linking system 102 determines the concept combinations 606 including subsets of concepts including each of the singleton sets (e.g., as [“attribute”], [“dataset”], and [“segment”]) and pairs of concepts (e.g., as [“attribute”, “dataset”], [“attribute”, “segment”], and [“dataset”, “segment”]). In alternative embodiments, the concept combinations 606 thus include all possible combinations of concepts identified in the natural language query 600 (including the full set) in a single set of searches on the concept graph 608.

Furthermore, as previously described, the schema linking system 102 determines whether the concept combinations 606 are in the concept graph 608 utilizing the dictionary 610 of the concept graph 608. For example, the schema linking system 102 searches the dictionary 610 for each of the concept combinations 606 to determine whether the dictionary 610 includes any keys matching the concept combinations 606. In some embodiments, the schema linking system 102 determines a formatting of the keys in the dictionary 610 for determining a formatting of the concept combinations 606 (e.g., comma separated values, concatenated values). In additional embodiments, the schema linking system 102 modifies an order of concepts in each of the concept combinations 606 to compare to the keys in the dictionary 610.

In one or more embodiments, the schema linking system 102 determines the table(s) 612 relevant to the natural language query 600 in response to determining that the dictionary 610 includes one or more keys that match the concept combinations 606. Specifically, in response to determining that a particular concept combination matches a key in the dictionary 610, the schema linking system 102 extracts the value corresponding to the key as one or more tables relevant to the natural language query 600. To illustrate, in response to determining that the concept combination [“attribute”, “dataset”] matches a key in the dictionary 610, the schema linking system 102 extracts the corresponding set of tables (e.g., [“T1”, “T3”]) from the value in the key-value mapping. In an additional example, referring to the dictionary 500 of FIG. 5, searching for a concept combination [C1, C3] returns the value [T2, T4, T5].

In one or more additional embodiments, the schema linking system 102 appends the results of each concept combination to a set relevant tables for the natural language query 600. For example, the schema linking system 102 appends a value from a matching key-value mapping to the table(s) 612. Furthermore, in some embodiments, the schema linking system 102 determines whether any tables in the table(s) 612 repeat via a union operation. To illustrate, in some embodiments involving a table assigned a plurality of concept tags that span a plurality of different hyper edges, searches that return more than one hyper edge mapped to the table return a plurality of sets of tables that each include the table. Thus, the schema linking system 102 identifies and removes duplicate entries for a particular table, if applicable.

In additional embodiments, the schema linking system 102 also appends one or more tables corresponding to relevant examples (e.g., from a question bank). To illustrate, the schema linking system 102 determines relevant examples conditioned on natural language queries. Accordingly, in one or more embodiments, the schema linking system 102 determines one or more tables corresponding to the relevant examples conditioned on the natural language queries (e.g., similar queries to the natural language query 600, such as via embeddings of the queries) and appends such tables to the table(s) 612 for use in performing one or more database queries on the combined set of tables. In one or more embodiments, the schema linking system 102 selects a threshold number of relevant examples for the natural language query 600 (e.g., the closest five examples) or the relevant examples that are within a threshold embedding distance of an embedding of the natural language query 600. In some embodiments, the relevant examples in the question bank also have corresponding ground truth structured database queries with the corresponding tables.

According to one or more embodiments, by utilizing a concept graph to select tables according to concepts extracted from a natural language query, the schema linking system 102 selects relevant tables in a database. Specifically, by utilizing a concept graph including hyper edges mapping tables to specific concepts in key-value mappings, the schema linking system 102 is able to select atomic tables containing information directly corresponding to specific entities indicated in the natural language query. Furthermore, the schema linking system 102 is also able to select bridge tables containing information about how two or more atomic tables are connected. Thus, the schema linking system 102 selects tables that are directly related to specific concepts in addition to tables that indicate how the different concepts are related.

FIG. 7 illustrates an embodiment of the schema linking system 102 utilizing relevant tables for a natural language query to perform a query on a database and return a result. For example, FIG. 7 illustrates that the schema linking system 102 utilizes a large language model to translate the natural language query to a structured database query. Furthermore, FIG. 7 illustrates that the schema linking system 102 utilizes the large language model to translate the results from the database query back to natural language.

In one or more embodiments, the schema linking system 102 determines a natural language query 700 from a client device. In particular, the natural language query 700 includes a request to perform one or more database operations on one or more databases via a graphical user interface that accepts natural language text input. As described above, the schema linking system 102 utilizes a concept graph to determine a set of relevant tables 702 for the natural language query 700 including relevant atomic tables and any relevant bridge tables. In one or more embodiments, the schema linking system 102 generates the concept graph prior to receiving the natural language query 700 (e.g., prior to performing database queries on the database) for efficiency. In some embodiments, the schema linking system 102 updates the concept graph in response to changes to a predetermined list of concepts (e.g., queryable concepts) or to one or more tables in the database.

According to one or more embodiments, the schema linking system 102 generates a prompt for a large language model 704 to generate a structured database query 706 formatted for performing operations at a database, such as a SQL query. In connection with generating the prompt for the large language model 704, the schema linking system 102 includes the set of relevant tables 702 in the prompt. For example, the schema linking system 102 generates the prompt including instructions to limit a query on the database to the set of relevant tables 702. The schema linking system 102 provides the prompt including the natural language query 700 and the set of relevant tables 702 to the large language model 704 to generate the structured database query 706.

In one or more embodiments, the schema linking system 102 provides the structured database query 706 to the database for executing one or more database operations at the database. In particular, the schema linking system 102 (or the database management system 110) executes the structured database query 706 at the database to perform one or more database operations on the set of relevant tables 702. In response, the database returns a structured database query result 708 for the set of relevant tables 702.

In some embodiments, the schema linking system 102 utilizes the large language model 704 to convert the structured database query result 708 to a natural language response 710. Specifically, the schema linking system 102 leverages the large language model 704 to convert the structured database query result 708 into a format understandable by a user in connection with the natural language query 700. In some embodiments, the schema linking system 102 provides context from the natural language query 700 with the structured database query result 708 in a prompt to the large language model 704 to generate the natural language response 710. For instance, the context includes the natural language query 700, one or more additional inputs provided with (e.g., prior to or after) the natural language query 700, application data, etc.

For example, in response to a natural language query of “Are there any segments that have been flagged as duplicates?” from a client device, the schema linking system 102 selects one or more tables relevant to the natural language query, generates a structured database query on the relevant table(s) to obtain the specific information. To illustrate, the schema linking system 102 utilizes the large language model 704 to generate a structured database query of “SELECT segmentId, name, pqlText FROM hkg_dim_segment WHERE pqlText IN (SELECT pqlText FROM hkg_dim_segment GROUP BY pqlText HAVING COUNT (*)>1).” Based on a result returned by the database, the schema linking system 102 generates a natural language response of “Segment 7 is a duplicate of segment 2,” and provides the natural language response for display at the client devices.

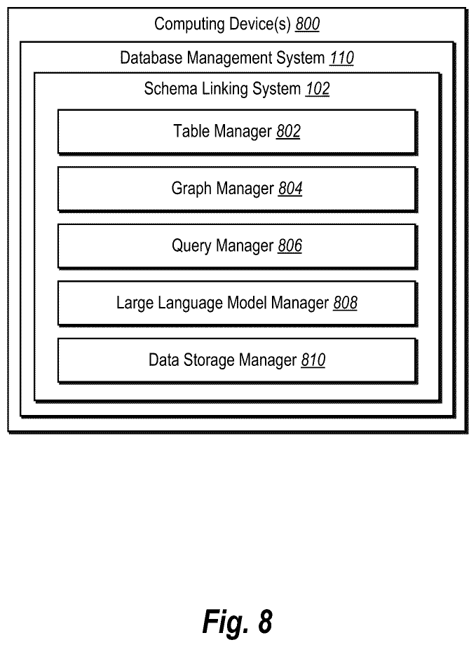

FIG. 8 illustrates a detailed schematic diagram of an embodiment of the schema linking system 102 described above. As shown, the schema linking system 102 is implemented in a database management system 110 on computing device(s) 800 (e.g., a client device and/or server device as described in FIG. 1, and as further described below in relation to FIG. 10). Additionally, the schema linking system 102 includes, but is not limited to, a table manager 802, a graph manager 804, a query manager 806, a LLM manager 808, and a data storage manager 810. In one or more embodiments, the schema linking system 102 is implemented on any number of computing devices. For example, the schema linking system 102, in one or more embodiments, is implemented in a distributed system of server devices for database management. Alternatively, the schema linking system 102 is also implemented within one or more additional systems. For example, the schema linking system 102, in one or more embodiments, is implemented on a single computing device such as a single client device.

In one or more embodiments, each of the components of the schema linking system 102 is in communication with other components using any suitable communication technologies. Additionally, the components of the schema linking system 102 are capable of being in communication with one or more other devices including other computing devices of a user, server devices (e.g., cloud storage devices), licensing servers, or other devices/systems. It will be recognized that although the components of the schema linking system 102 are shown to be separate in FIG. 8, in other embodiments, any of the subcomponents are combined into fewer components, such as into a single component, or divided into more components as serve a particular implementation. Furthermore, although the components of FIG. 8 are described in connection with the schema linking system 102, at least some of the components for performing operations in conjunction with the schema linking system 102 described herein are implemented on other devices within the environment in other embodiments.

In some embodiments, the components of the schema linking system 102 include software, hardware, or both. For example, the components of the schema linking system 102 include one or more instructions stored on a computer-readable storage medium and executable by processors of one or more computing devices (e.g., the computing device(s) 800). When executed by the one or more processors, the computer-executable instructions of the schema linking system 102 cause the computing device(s) 800 to perform the operations described herein. Alternatively, the components of the schema linking system 102 include hardware, such as a special purpose processing device to perform a certain function or group of functions. Additionally, or alternatively, the components of the schema linking system 102 include a combination of computer-executable instructions and hardware.

Furthermore, the components of the schema linking system 102 performing the functions described herein with respect to the schema linking system 102, for example, are implemented as part of a stand-alone application, as a module of an application, as a plug-in for applications, as a library function or functions called by other applications, and/or as a cloud-computing model. Thus, in some embodiments, the components of the schema linking system 102 are implemented as part of a stand-alone application on a personal computing device or a mobile device. Alternatively, or additionally, the components of the schema linking system 102 are implemented in any application that provides database management or campaign management, including, but not limited to ADOBE® EXPERIENCE CLOUD®, ADOBE® EXPERIENCE PLATFORM, and ADOBE® CAMPAIGN software.

As illustrated in FIG. 8, the schema linking system 102 includes a table manager 802 to manage tables in one or more databases. For example, the table manager 802 obtains or accesses tables in a database. Additionally, the table manager 802 generates, obtains, or accesses information about the tables, including table descriptions, row/column names, cell contents, metadata, or other data associated with tables in a database.

In one or more embodiments, the schema linking system 102 includes a graph manager 804 to generate one or more concept graphs associated with one or more databases. For instance, the graph manager 804 generates concept graphs by determining relationships between specific concepts and tables in one or more databases. To illustrate, the graph manager 804 accesses table data from the table manager 802 and one or more lists of concepts (e.g., predetermined/allowed concepts for database queries) to determine relationships between the tables and graphs. Additionally, the graph manager 804 generates concept graphs by generating dictionaries of key-value mappings indicating the links between tables and concepts.

In one or more embodiments, the schema linking system 102 includes a query manager 806 to manage queries to one or more databases. For example, the query manager 806 utilizes concept graphs to select relevant tables for natural language queries. To illustrate, the query manager 806 uses indicated concepts in the natural language queries to determine relevant tables via one or more concept graphs (e.g., by matching the indicated concepts to keys in key-value mappings and extracting the corresponding values).

In some embodiments, the schema linking system 102 includes a LLM manager 808 (i.e., a large language model manager) to utilize a large language model to execute database queries based on natural language queries. For example, the LLM manager 808 utilizes a large language model to convert natural language queries to structured database queries for executing one or more database operations. Additionally, the LLM manager 808 utilizes the large language model to convert results of structured database queries to natural language responses.

The schema linking system 102 also includes a data storage manager 810 (that comprises a non-transitory computer memory) that stores and maintains data associated with managing and querying databases. For example, the data storage manager 810 stores information about databases, tables in databases, concepts, and concept graphs. Furthermore, the data storage manager 810 stores data in connection with interpreting natural language queries and executing database operations based on the natural language queries, such as natural language queries, relevant tables, structured database queries, and responses to structured database queries.

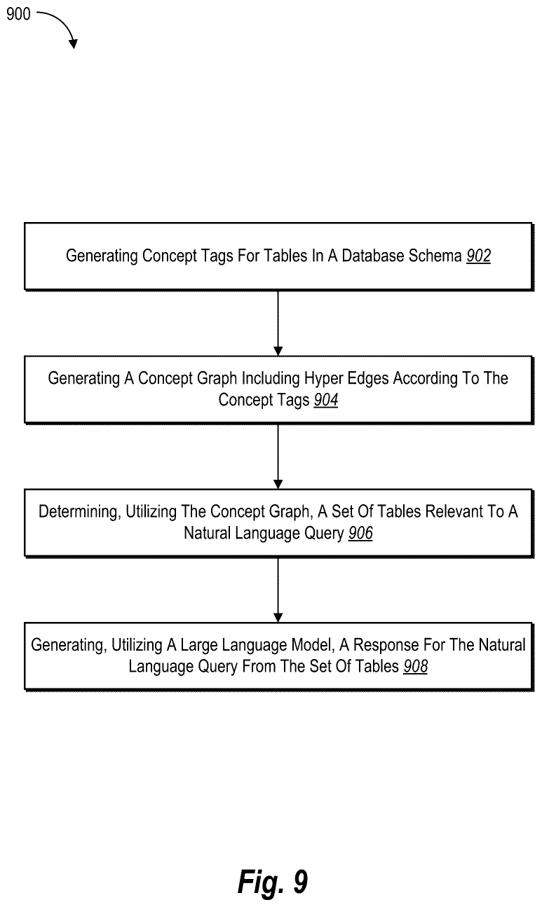

Turning now to FIG. 9, this figure shows a flowchart of a series of acts 900 of generating and utilizing concept graphs linking database tables to specific concepts for determining tables relevant to natural language queries. While FIG. 9 illustrates acts according to one embodiment, alternative embodiments may omit, add to, reorder, and/or modify any of the acts shown in FIG. 9. The acts of FIG. 9 are part of a method. Alternatively, a non-transitory computer readable medium comprises instructions, that when executed by one or more processors, cause the one or more processors to perform the acts of FIG. 9. In still further embodiments, a system includes a processor or server configured to perform the acts of FIG. 9.

As shown, the series of acts 900 includes an act 902 of generating concept tags for tables in a database schema. The series of acts 900 also includes an act 904 of generating a concept graph including hyper edges according to the concept tags. Additionally, the series of acts 900 includes an act 906 of determining, utilizing the concept graph, a set of tables relevant to a natural language query. The series of acts 900 also includes an act 908 of generating, utilizing a large language model, a response for the natural language query from the set of tables.

In one or more embodiments, act 902 involves generating concept tags for tables in a database schema based on content of the tables corresponding to concepts in a predetermined list of concepts. Furthermore, act 904 involves generating a concept graph comprising hyper edges linking the tables to the concepts according to the concept tags of the tables. Act 906 involves determining, from the tables in the database schema, a set of tables relevant to a natural language query comprising an indicated concept by extracting the set of tables from one or more hyper edges corresponding to the indicated concept from the concept graph. Additionally, act 908 involves generating, utilizing a large language model, a response for the natural language query from the set of tables relevant to the natural language query.

In one or more embodiments, the series of acts 900 includes extracting one or more concepts from content of a table in the database schema. The series of acts 900 also includes generating one or more concept tags for the table in response to determining that the one or more concepts extracted from the content of the table matches one or more concepts in the predetermined list of concepts.

In one or more embodiments, the series of acts 900 includes determining a first table and a second table that are tagged with a first concept tag corresponding to a first concept in the predetermined list of concepts and a second concept tag corresponding to a second concept in the predetermined list of concepts. Furthermore, the series of acts 900 includes generating a hyper edge linking the first table and the second table to the first concept and the second concept.

In additional embodiments, the series of acts 900 includes generating a dictionary of key-value mappings in the concept graph comprising the hyper edge as a key with the first table as a first value assigned to the key and the second table as a second value assigned to the key. For example, the series of acts 900 includes generating the key for the hyper edge as a combination of a plurality of concepts corresponding to the hyper edge. In additional examples, the series of acts 900 includes comparing the indicated concept to a plurality of keys in the concept graph to determine that the indicated concept matches the key of the hyper edge. The series of acts 900 also includes extracting, from the concept graph, one or more values assigned to the key indicating one or more tables relevant to the natural language query.

In one or more embodiments, the series of acts 900 includes determining that the natural language query includes a plurality of indicated concepts in the predetermined list of concepts. The series of acts 900 also includes determining that the plurality of indicated concepts matches a plurality of keys corresponding to a plurality of hyper edges in the concept graph. Additionally, the series of acts 900 includes extracting a plurality of tables from values of the plurality of hyper edges corresponding to the plurality of indicated concepts.

In one or more embodiments, the series of acts 900 includes generating one or more normalized tokens for one or more character strings in the natural language query, and comparing the one or more normalized tokens to the predetermined list of concepts to determine that the natural language query includes the indicated concept. The series of acts 900 also includes determining that a combined set of tokens from the natural language query does not match keys in the concept graph. Additionally, the series of acts 900 includes determining a subset of tokens of the combined set of tokens from the natural language query, and selecting one or more tables relevant to the natural language query in response to determining that the subset of tokens matches a key in the concept graph.

In one or more embodiments, the series of acts 900 includes generating a concept graph comprising hyper edges linking tables in a database schema to concepts in a predetermined list of concepts according to concept tags of the tables based on content of the tables. The series of acts 900 also includes determining, from the tables in the database schema, a set of tables relevant to a natural language query comprising a plurality of indicated concepts by extracting the set of tables from stored values in a set of hyper edges corresponding to the plurality of indicated concepts from the concept graph. The series of acts 900 also includes generating, utilizing a large language model, a response for the natural language query from the set of tables relevant to the natural language query.

In some embodiments, the series of acts 900 includes determining relationships between the tables in the database schema and the concepts in the predetermined list of concepts based on content of the tables. The series of acts 900 further includes generating concept tags for the tables according to the relationships between the tables and the concepts in the predetermined list of concepts.

In one or more embodiments, the series of acts 900 includes determining that a table in the database schema is are tagged with a first concept tag corresponding to a first concept in the predetermined list of concepts and a second concept tag corresponding to a second concept in the predetermined list of concepts. The series of acts 900 also includes generating a first hyper edge linking the table to the first concept and a second hyper edge linking the table to the second concept.

In one or more embodiments, the series of acts 900 includes generating a dictionary of key-value mappings in the concept graph comprising the hyper edges as keys with the tables in the database schema as values assigned to corresponding keys.

In some embodiments, the series of acts 900 includes generating a plurality of tokens for a plurality of character strings in the natural language query. The series of acts 900 also includes comparing the plurality of tokens to the predetermined list of concepts to determine that the natural language query includes the plurality of indicated concepts based on a subset of tokens in the natural language query that match a subset of concepts in the predetermined list of concepts. Additionally, the series of acts 900 includes determining the set of tables relevant to the natural language query utilizing the subset of tokens in the natural language query. The series of acts 900 also includes determining that one or more combinations of tokens of the subset of tokens in the natural language query matches a key in the concept graph, and extracting one or more values indicating the set of tables relevant to the natural language query from one or more key-value mappings corresponding to the key in the concept graph.

In one or more embodiments, the series of acts 900 includes generating, for the large language model, a prompt comprising a structured database query for the natural language query indicating the set of tables relevant to the natural language query.

In one or more embodiments, the series of acts 900 includes generating a concept graph comprising hyper edges linking tables in a database schema to concepts in a predetermined list of concepts by generating values in the hyper edges according to concept tags of the tables based on content of the tables. Additionally, the series of acts 900 includes determining, from the tables in the database schema, a set of tables relevant to a natural language query by: determining one or more indicated concepts from the natural language query; and extracting the set of tables from values in a set of hyper edges corresponding to the one or more indicated concepts from the concept graph. Furthermore, the series of acts 900 includes generating, utilizing a large language model, a response for the natural language query from the set of tables relevant to the natural language query.

In one or more embodiments, the series of acts 900 includes determining the concept tags based on the predetermined list of concepts, extracting text from the tables in the database schema, and assigning the tables to the concept tags based on the text extracted from the tables.

In one or more embodiments, the series of acts 900 includes generating normalized tokens for words in the natural language query by tokenizing base terms corresponding to the words in the natural language query. For example, the series of acts 900 includes determining that a subset of the normalized tokens match one or more keys corresponding to the set of hyper edges in the concept graph.

In some embodiments, the series of acts 900 includes generating a prompt comprising a structure database query indicating the set of tables and the set of tables relevant to the natural language query, and providing the prompt to the large language model to generate the response.

Embodiments of the present disclosure may comprise or utilize a special purpose or general purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions from a non-transitory computer-readable medium (e.g., memory) and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or generators and/or other electronic devices. When information is transferred, or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface generator (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general purpose computer, special purpose computer, or special purpose processing device to perform a certain function or group of functions. In some embodiments, computer-executable instructions are executed by a general purpose computer to turn the general purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program generators may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), a web service, Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 10 illustrates a block diagram of an example computing device 1000 that may be configured to perform one or more of the processes described above. One will appreciate that one or more computing devices, such as the computing device 1000, may represent the computing devices described above (e.g., the computing device(s) 800, the server device(s) 104, or the client device 106). In one or more embodiments, the computing device 1000 may be a mobile device (e.g., a mobile telephone, a smartphone, a PDA, a tablet, a laptop, a camera, a tracker, a watch, a wearable device, etc.). In some embodiments, the computing device 1000 may be a non-mobile device (e.g., a desktop computer or another type of client device). Further, the computing device 1000 may be a server device that includes cloud-based processing and storage capabilities.

As shown in FIG. 10, the computing device 1000 can include one or more processor(s) 1002, memory 1004, a storage device 1006, input/output interfaces 1008 (or “I/O interfaces 1008”), and a communication interface 1010, which may be communicatively coupled by way of a communication infrastructure (e.g., bus 1012). While the computing device 1000 is shown in FIG. 10, the components illustrated in FIG. 10 are not intended to be limiting. Additional or alternative components may be used in other embodiments. Furthermore, in certain embodiments, the computing device 1000 includes fewer components than those shown in FIG. 10. Components of the computing device 1000 shown in FIG. 10 will now be described in additional detail.

In particular embodiments, the processor(s) 1002 includes hardware for executing instructions, such as those making up a computer program. As an example, and not by way of limitation, to execute instructions, the processor(s) 1002 may retrieve (or fetch) the instructions from an internal register, an internal cache, memory 1004, or a storage device 1006 and decode and execute them.

The computing device 1000 includes the memory 1004, which is coupled to the processor(s) 1002. The memory 1004 may be used for storing data, metadata, and programs for execution by the processor(s). The memory 1004 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1004 may be internal or distributed memory.

The computing device 1000 includes the storage device 1006 for storing data or instructions. As an example, and not by way of limitation, the storage device 1006 can include a non-transitory storage medium described above. The storage device 1006 may include a hard disk drive (“HDD”), flash memory, a Universal Serial Bus (“USB”) drive or a combination these or other storage devices.

As shown, the computing device 1000 includes one or more I/O interfaces 1008, which are provided to allow a user to provide input to (such as user strokes), receive output from, and otherwise transfer data to and from the computing device 1000. These I/O interfaces 1008 may include a mouse, keypad or a keyboard, a touch screen, camera, optical scanner, network interface, modem, other known I/O devices or a combination of such I/O interfaces 1008. The touch screen may be activated with a stylus or a finger.

The I/O interfaces 1008 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1008 are configured to provide graphical data to a display for presentation to a user. The graphical data may be representative of one or more graphical user interfaces and/or any other graphical content as may serve a particular implementation.

The computing device 1000 can further include a communication interface 1010. The communication interface 1010 can include hardware, software, or both. The communication interface 1010 provides one or more interfaces for communication (such as, for example, packet-based communication) between the computing device and one or more other computing devices or one or more networks. As an example, and not by way of limitation, communication interface 1010 may include a network interface controller (“NIC”) or network adapter for communicating with an Ethernet or other wire-based network or a wireless NIC (“WNIC”) or wireless adapter for communicating with a wireless network, such as a WI-FI. The computing device 1000 can further include the bus 1012. The bus 1012 can include hardware, software, or both that connects components of computing device 1000 to each other.

The use in the foregoing description and in the appended claims of the terms “first,” “second,” “third,” etc., is not necessarily to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget, and not necessarily to connote that the second widget has two sides.

In the foregoing description, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with fewer or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
generating, by one or more server devices, concept tags for tables in a database schema based on content of the tables corresponding to concepts in a predetermined list of concepts;
generating, by the one or more server devices, a concept graph comprising hyper edges linking the tables to the concepts according to the concept tags of the tables;
determining, by the one or more server devices and from the tables in the database schema, a set of tables relevant to a natural language query comprising an indicated concept by extracting the set of tables from one or more hyper edges corresponding to the indicated concept from the concept graph; and
generating, by the one or more server devices utilizing a large language model, a response for the natural language query from the set of tables relevant to the natural language query.

2. The computer-implemented method of claim 1, wherein generating the concept tags for the tables in the database schema comprises:
extracting one or more concepts from content of a table in the database schema; and
generating one or more concept tags for the table in response to determining that the one or more concepts extracted from the content of the table matches one or more concepts in the predetermined list of concepts.

3. The computer-implemented method of claim 1, wherein generating the concept graph comprises:
determining a first table and a second table that are tagged with a first concept tag corresponding to a first concept in the predetermined list of concepts and a second concept tag corresponding to a second concept in the predetermined list of concepts; and
generating a hyper edge linking the first table and the second table to the first concept and the second concept.

4. The computer-implemented method of claim 3, wherein generating the hyper edge comprises generating a dictionary of key-value mappings in the concept graph comprising the hyper edge as a key with the first table as a first value assigned to the key and the second table as a second value assigned to the key.

5. The computer-implemented method of claim 4, further comprising generating the key for the hyper edge as a combination of a plurality of concepts corresponding to the hyper edge.

6. The computer-implemented method of claim 4, wherein determining the set of tables relevant to the natural language query comprises:
comparing the indicated concept to a plurality of keys in the concept graph to determine that the indicated concept matches the key of the hyper edge; and
extracting, from the concept graph, one or more values assigned to the key indicating one or more tables relevant to the natural language query.

7. The computer-implemented method of claim 5, wherein determining the set of tables relevant to the natural language query comprises:
determining that the natural language query includes a plurality of indicated concepts in the predetermined list of concepts;
determining that the plurality of indicated concepts matches a plurality of keys corresponding to a plurality of hyper edges in the concept graph; and
extracting a plurality of tables from values of the plurality of hyper edges corresponding to the plurality of indicated concepts.

8. The computer-implemented method of claim 1, further comprising:
generating one or more normalized tokens for one or more character strings in the natural language query; and
comparing the one or more normalized tokens to the predetermined list of concepts to determine that the natural language query includes the indicated concept.

9. The computer-implemented method of claim 7, wherein determining the set of tables relevant to the natural language query comprises:
determining that a combined set of tokens from the natural language query does not match keys in the concept graph;
determining a subset of tokens of the combined set of tokens from the natural language query; and
selecting one or more tables relevant to the natural language query in response to determining that the subset of tokens matches a key in the concept graph.

10. A system comprising:
one or more memory devices comprising a database schema; and
one or more server devices configured to:
generate a concept graph comprising hyper edges linking tables in a database schema to concepts in a predetermined list of concepts according to concept tags of the tables based on content of the tables;
determine, from the tables in the database schema, a set of tables relevant to a natural language query comprising a plurality of indicated concepts by extracting the set of tables from stored values in a set of hyper edges corresponding to the plurality of indicated concepts from the concept graph; and
generate, utilizing a large language model, a response for the natural language query from the set of tables relevant to the natural language query.

11. The system of claim 10, wherein the one or more server devices are further configured to generate the concept graph by:
determining relationships between the tables in the database schema and the concepts in the predetermined list of concepts based on content of the tables; and
generating concept tags for the tables according to the relationships between the tables and the concepts in the predetermined list of concepts.

12. The system of claim 10, wherein the one or more server devices are further configured to generate the concept graph by:
determining that a table in the database schema is are tagged with a first concept tag corresponding to a first concept in the predetermined list of concepts and a second concept tag corresponding to a second concept in the predetermined list of concepts; and
generating a first hyper edge linking the table to the first concept and a second hyper edge linking the table to the second concept.

13. The system of claim 10, wherein the one or more server devices are further configured to generate the concept graph by generating a dictionary of key-value mappings in the concept graph comprising the hyper edges as keys with the tables in the database schema as values assigned to corresponding keys.

14. The system of claim 10, wherein the one or more server devices are further configured to determine the set of tables relevant to the natural language query by:
generating a plurality of tokens for a plurality of character strings in the natural language query;
comparing the plurality of tokens to the predetermined list of concepts to determine that the natural language query includes the plurality of indicated concepts based on a subset of tokens in the natural language query that match a subset of concepts in the predetermined list of concepts; and
determining the set of tables relevant to the natural language query utilizing the subset of tokens in the natural language query.

15. The system of claim 14, wherein the one or more server devices are further configured to determine the set of tables relevant to the natural language query by:
determining that one or more combinations of tokens of the subset of tokens in the natural language query matches a key in the concept graph; and
extracting one or more values indicating the set of tables relevant to the natural language query from one or more key-value mappings corresponding to the key in the concept graph.

16. The system of claim 10, wherein the one or more server devices are further configured to generate the response for the natural language query by generating, for the large language model, a prompt comprising a structured database query for the natural language query indicating the set of tables relevant to the natural language query.

17. A computer-implemented method comprising:
performing a step for generating a concept graph comprising hyper edges linking tables in a database schema to concepts in a predetermined list of concepts;
determining, from the tables in the database schema, a set of tables relevant to a natural language query by:
determining one or more indicated concepts from the natural language query; and
extracting the set of tables from values in a set of hyper edges corresponding to the one or more indicated concepts from the concept graph; and
generating, utilizing a large language model, a response for the natural language query from the set of tables relevant to the natural language query.

18. The computer-implemented method of claim 17, wherein determining the set of tables relevant to the natural language query comprises:
generating normalized tokens for words in the natural language query by tokenizing base terms corresponding to the words in the natural language query; and
determining that a subset of the normalized tokens match one or more keys corresponding to the set of hyper edges in the concept graph.

19. The computer-implemented method of claim 18, wherein determining the set of tables relevant to the natural language query comprises extracting one or more values indicating one or more tables relevant to the natural language query from one or more key-value mappings corresponding to the one or more keys in the concept graph.

20. The computer-implemented of claim 17, wherein generating the response for the natural language query comprises:
generating a prompt comprising a structure database query indicating the set of tables and the set of tables relevant to the natural language query; and
providing the prompt to the large language model to generate the response.
